(19) United States
(12) Patent Application Publication
(10) Pub. No.: US 2017/0283151 A1
(43) Pub. Date: Oct. 5, 2017

(54) MEDICATION SYSTEM

(71) Applicant: CARDINAL HEALTH COMMERCIAL TECHNOLOGIES, LLC., Dublin, OH (US)

(72) Inventors: BENJAMIN E. STORMER, Worthington, OH (US); James Lee Shingler, Westerville, OH (US); Craig Daniel Courtney, Dublin, OH (US); Kartik Iyengar, Bangalore (IN)

(73) Assignee: CARDINAL HEALTH COMMERCIAL TECHNOLOGIES, LLC., Dublin, OH (US)

(21) Appl. No.: 15/465,793

(22) Filed: Mar. 22, 2017

Related U.S. Application Data
(60) Provisional application No. 62/317,049, filed on Apr. 1, 2016.

(51) Int. Cl. B65D 79/00; B65D 75/36; G06F 19/00; A61J 1/03

(52) U.S. Cl. CPC B65D 79/00; A61J 1/035; B65D 75/367; G06F 19/3456; A61J 2200/30

(57) ABSTRACT

A medication system includes a blister pack. The blister pack includes a sheet containing a plurality of blisters each respectively containing at least one medication. The blister pack further includes a backing positioned on the sheet and a substrate layer having electronic circuitry thereon, the circuitry including traces terminating at one end at positions corresponding to each of the blisters. The blister pack is connected to an edge connector disposed adjacent to an edge of the sheet, the traces terminating at an other end to the edge connector. The medication system also includes a hub in electronic communication with the blister pack. The traces positioned such that each time a blister is punctured, the breakage event is communicated to the hub and recorded.

### BACKGROUND

Patients may be prescribed multiple medications to treat various conditions. Additionally, patients may regularly take non-prescription drugs (e.g., aspirin) or supplements. Accordingly, some patients may need to manage a regimen involving multiple medications.

Current medication management solutions, such as pill sorters, still require the patients or caregivers to manually sort and track medications. Compliance with a complicated medication regimen may be difficult for patients. Further, care providers may not know whether a patient is complying with a medication regimen, which may affect the ability of the care provider to assess the effectiveness of the medication regimen.

In view of the foregoing, as well as other factors, there remains a need for improvements over current medication dispensing procedures.

### SUMMARY

Embodiments of the disclosure provide for a method and system for managing various aspects of a patient's health, such as medications, testing, subjective evaluation, communications, education, and appointments (such method and system also interchangeably referred to herein as a “wellness solution.” The wellness solution may include a system and method that includes a medication dispensing device, such as a blister pack, and/or use thereof. The wellness solution may include a user interface for communicating with the patient or caregiver. The wellness solution may receive medication information and may use the medication information to alert the patient to take a dose of the medication according to a regimen, for example. The wellness solution may also interact with the patient to obtain biometric information and subjective health information, for example. The wellness solution may communicate with a network to provide regimen compliance information, for example, along with the collected biometric and/or subjective health information.

The system and method may also include a remote application allowing a pharmacist to manage a medication schedule of a patient, and allowing the various components of the wellness solution to be linked to each other and to the patient among other features. The remote application may also allow a pharmacist to monitor for health changes in a patient, change prescription schedules for the patient, and help educate a patient, for example.

The system and method may also optionally include one or more cloud-based computer servers for managing the medication dispensing device, remote applications, mobile applications running on the system, and any other devices interacting with the system. The computer servers may also receive data generated by the medication dispensing device, the remote application, the mobile application, and/or devices interacting with the system and may analyze the received data and perform calculations on the received data.

Additional advantages and novel features of these embodiments will be set forth in part in the description that follows, and in part will become more apparent to those skilled in the art upon examination of the following or upon learning by practice thereof.

### BRIEF DESCRIPTION OF THE DRAWINGS

The disclosed embodiments will hereinafter be described in conjunction with the appended drawings, provided to illustrate example features and not to limit the disclosed embodiments, wherein like designations denote like elements, and in which:

FIG. 1A illustrates an example system for use in accordance with an embodiment;

FIG. 1B illustrates a top view of a blister pack for use in accordance with an embodiment;

FIG. 1C illustrates a bottom view of a blister pack for use in accordance with an embodiment;

FIG. 2 illustrates an example method flow for initializing a medication schedule in accordance with an embodiment;

FIGS. 3A-3E illustrate an example method flow for managing a medication schedule for a patient in accordance with an embodiment;

FIG. 4 illustrates an example method flow for prompting a patient to take medicine in accordance with an embodiment;

FIG. 5 illustrates an example method flow for gathering information from peripheral devices in accordance with an embodiment;

FIG. 6 illustrates an example method flow for gathering health and wellness information in accordance with an embodiment;

FIGS. 7A and 7B illustrate an example method flow for establishing a travel mode in accordance with an embodiment;

FIG. 8 illustrates an example method flow for calculating a compliance score in accordance with an embodiment;

FIG. 9 illustrates an example method flow for transmitting alerts in accordance with an embodiment;

FIG. 10 illustrates an example method flow for determining behavioral analytics in accordance with an embodiment; and

FIG. 11 illustrates an example method flow for risk management in accordance with an embodiment.

### DETAILED DESCRIPTION

Various embodiments are now described with reference to the drawings. In the following description, for purposes of explanation, numerous specific example details are set forth in order to provide a thorough understanding of one or more embodiments. It may be evident, however, that such embodiments may be practiced without these specific details.

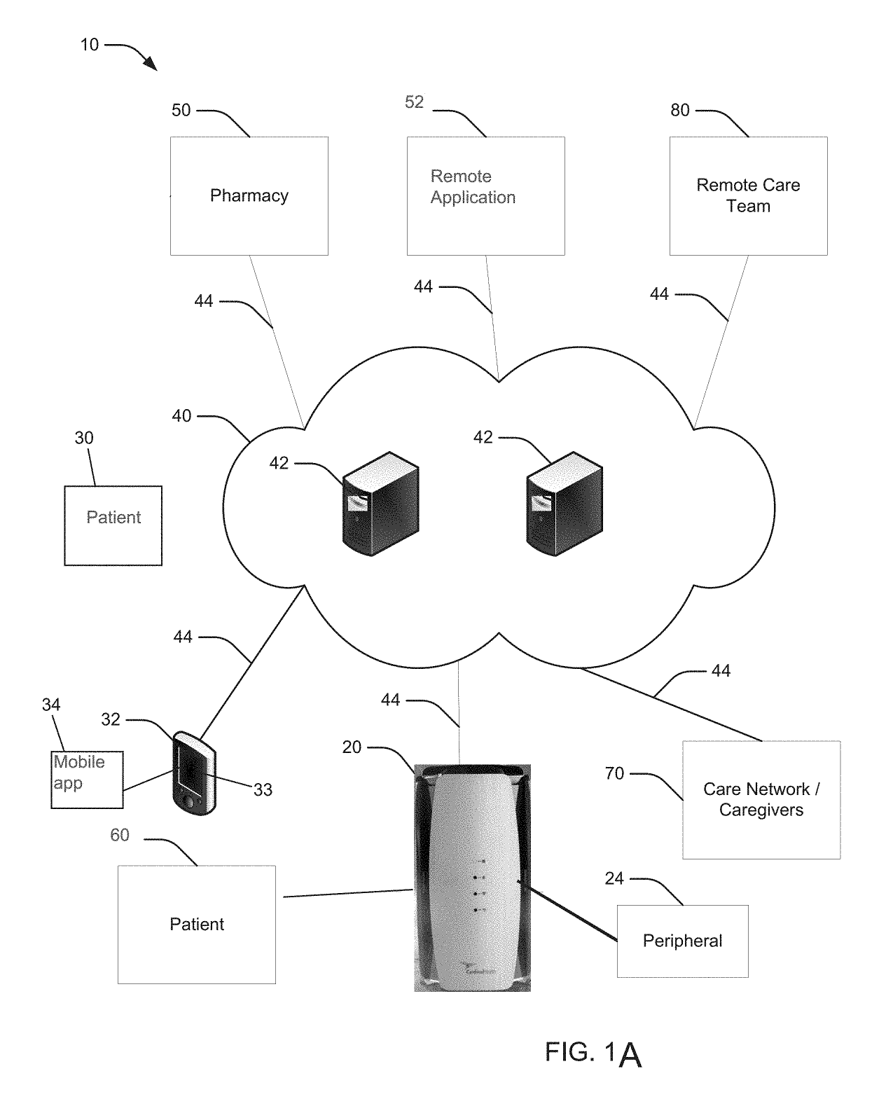

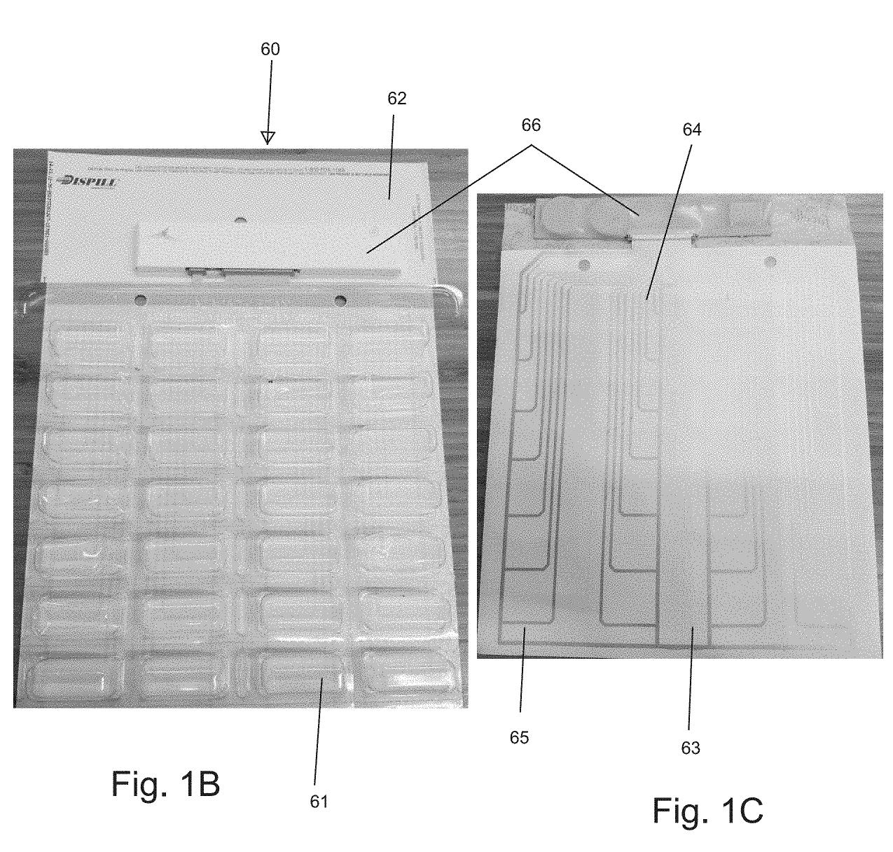

FIG. 1 illustrates an example system 10 including features for operating a wellness solution for managing various embodiments of a patient's health, such as medications, testing, subjective evaluation, communications, education, and appointments, and method of operation thereof. System 10 may include a medication dispensing device, such as a blister pack 60. Medication dispensing device 60 may store medications (e.g., solid oral medications) to be dispensed to a patient 30. Medication dispensing device 60 may be located in the patient's home, office or other convenient location, for example. Medication dispensing device may allow patients to access one or more medications to the patient at various times according to prescribed dosage schedules. Medication dispensing device 60 may include multiple blisters 61 containing medication. A mobile device 32 having therein a mobile application 34 may control the dispensing of medication and information presented via a user interface 33, for example.

In an exemplary embodiment, a blister package 60 (“blister pack”) having a plurality of blisters 61 is shown in FIG. 1. The blister pack 60 may be made of plastic and includes a plurality of protruding, block-shaped blisters 61 to store one or more medications to be consumed by a patient at various times throughout the day (e.g., morning, afternoon, evening, bedtime) for a given period of time (e.g., a month or a week). Conventionally, a pharmacist or other caregiver prepares a sealed blister pack 60 for a patient for the given period of time (e.g., a week or a month). The patient punctures the appropriate blister 61 at the appropriate time to remove the medications contained therein. For example, at Monday at 9:00 am, the patient punctures the blister 61 corresponding to the Monday morning dose.

The blisters 61 are then covered and sealed by a generally thin, flexible backing, 62 made of paper, metal foil, or the like. The backing 62 is to be punctured by a patient seeking to remove medication contained therein to be consumed. According to an exemplary embodiment of the present invention, the backing 62 includes a substrate layer 63 having electronic circuitry 64 embedded or printed thereon (e.g., a printed circuit board). The circuitry 64 includes traces 65 terminating at positions corresponding to each of the blisters 61. Specifically, the traces 65 are positioned such that each time a blister 61 is punctured, the circuit “breaks” at that position and the breakage event is recorded and later intelligently processed.

The traces 65 each terminate in a connection to an edge connector 66. According to an exemplary embodiment, the edge connector 66 is an electronic module that contains a communication device (such as Wi-Fi, Bluetooth, Bluetooth Low-Energy (BLE), or Zigbee), a memory, a micro-controller, a real-time clock, and a power source (e.g., a battery). Accordingly, when the patient punctures one of the blisters 61, the trace 65 corresponding to the punctured blister 61 sends a signal to the edge connector 66, whereby the clock within the edge connector 66 records the time of the puncture in its local memory, and using the communication device, sends a signal to the hub 20 of the puncture event.

The backing 62 and substrate layer 63 are not suitable for re-usability, as the puncturing of the blisters 61 renders the backing 62 and substrate layers 63 permanently damaged. Thus, the backing 62 are to be used for the duration of one medication regimen (e.g., one week or one month) and discarded thereafter. The electronic components of the edge connector 66, however, may be recycled and re-used.

The hub 20 is a gateway device that receives data regarding the puncture of a blister 61 at a particular time from the substrate layer 63 (via the edge connector 66) and sends that data to the cloud 40.

In some embodiments, only a single blister pack 60 is expected to be in active communication with the hub 20 at any given time. In other embodiments, multiple blister packs 60 may be connected to a single hub 20. For example, members of the same household or residents of a nursing home/other care facility each having their own blister packs 60 may find it useful to connect to a single hub 20.

The hub 20 and blister pack 60 may work in conjunction with a companion mobile application 34 (“mobile app”). The mobile app 34 may be stored on a patient's mobile device 32 (e.g., smart cellular phone, a tablet computer, or other mobile computing device). In exemplary embodiments, the mobile app 34 downloads or otherwise has access to the patient's medication schedule. Upon determining from the schedule that a pre-defined dose window has begun (e.g., the morning dose window), the app transmits an alert and/or notification in real-time to the patient to take the medication for that day and dose window. Upon the patient successfully puncturing the blister corresponding to the current day and dose window, the edge connector 66 sends a notification to the hub 20, which then sends a notification to the cloud 40, which then sends a notification to the mobile app 34 that the dose has been successfully taken. The event is recorded locally on the patient's mobile device 32 and/or stored in the cloud 40.

In an exemplary embodiment, the active shelf life of the blister pack 60 may be two months from the time of manufacture. The blister pack 60 will have enough power (from a battery or solar cell) to get through any patient's longest monthly drug regimen and additional time to account for a worst case retry scenario. Battery life can be further extended as is known in the art.

In exemplary embodiments, the blister pack 60 and hub 20 communicate with each other through a Bluetooth Low-Energy (BLE) connection. However, other communication methods may be used, such as classic Bluetooth or Zigbee. In an exemplary embodiment, the blister pack 60 and hub 20 can function at a distance of up to approximately 30-40 m. In the event of a connectivity break between the blister pack 60 and hub 20, the blister pack 60 may locally cache the blister-breaking event until the connection is resumed, or may attempt to communicate with the hub 20 at a regular interval until the event is recorded by hub 20. The blister pack 60 can be programmed to work only with the hub 20. However, in other embodiments, the blister pack 60 may work with a “smart” cellular telephone, a tablet computer, a laptop computer, or another connector/aggregator for the Internet of Things (e.g., Amazon Echo).

In an exemplary embodiment, the blisters 61 are labeled so as to be consumed sequentially according to a prescribed medication regimen. For example, a patient's physician may prescribe medications to be consumed in distinct time periods: the morning, afternoon, evening, and bedtime. Accordingly, the blisters 61 may be labeled by time period and date, for example, Apr. 1, 2016 morning. The traces 65 on the blister pack 60 report to the hub 20 in real-time that a particular blister has been punctured. Accordingly, the hub 20 sends the information to the cloud 40 where the event is recorded.

The system 10 may assume that the medication in the blister pack 60 is taken in the correct sequence as prescribed. If there's any tampering of the blister pack 60, then the system 10 may consider the impacted blister(s) 61 to be damaged and may advise the patient 30 to skip the dosage of the damaged blister(s). In some embodiments, the skipping of the damaged blister(s) 61 can be overridden by the patient, pharmacist, or other caregiver.

The blister pack 60 may allow patients to access medications provided by a pharmacy 50 or other appropriately licensed entity, such as a physician office. In an embodiment, a medication may include a solid oral medication (e.g., pills, caplets, capsules, gel caps, or tablets). In an embodiment, the medication may include a prescription medication. The medication may also include over the counter medicine, vitamins, supplements, placebos, experimental drugs not yet approved for sale, or other substances that may be dispensed to the patient 30. The pharmacy 50 may provide medications to the patient for storage in the blister pack 60. The pharmacy 50 may receive prescription information from a doctor via written or electronic script, for example. In addition, the pharmacy 50 may receive prescription information via the cloud 40, such as through a remote application 52. The pharmacy 50 may also receive prescription information from an electronic medical record of the patient. The pharmacy 50 may fill the prescription and provide the medications to the patient 30 or caregiver 70 in a blister pack 60, for example. The pharmacy 50 may submit medication information to the cloud 40 using the remote application 52, indicating the type, total mass, container mass, mass per dose, and/or other medication properties for each medication.

Mobile device 32 may communicate with the patient 30 via, for example, user interface 33 of mobile app 34. Mobile app 34 may also communicate with the patient 30 via other features (e.g., an alarm), and/or a peripheral device 24. In an embodiment, a caregiver 70 or other party, such as a member of a care network, a family member, a pharmacist, or medical provider, may interact with mobile app 34.

The peripheral device 24 may include any suitable device that may obtain medical or biometric data from a patient. For example, the peripheral device 24 may comprise a glucometer, cardiac monitor, thermometer, respiratory monitor, sleep monitor, pulse oximeter, body scale, inhaler, nebulizer, fitness tracker, blood pressure cuff, syringe, stethoscope, breathalyzer, mobile telephone sensor, etc. The peripheral device 24 may provide measurements or biometric data to the mobile app 34, for example, which may in turn transmit the measurements or biometric data to other devices via the cloud 40. In addition, the peripheral device 24 may provide measurements or biometric data to the hub 20, which may in turn transmit the measurements or biometric data to server 42.

The hub 20 may be communicatively coupled to the cloud 40 via a network, for example, the Internet, that allows communication between the various entities of the system 10. For example, the hub 20 may include a modem and may be coupled to the cloud 40 via a wireless connection. The cloud 40 may include one or more computer servers 42. Computer server(s) 42 may include information for managing a patient's medication dosage schedule and/or a peripheral device 24. In an embodiment, for example, computer servers 42 may include device servers for controlling one or more mobile applications 34, notification servers for providing messages to the patient 30, caregivers 70, or others, such as a remote care team 80. Servers 42 may also receive data generated by the blister pack 60 and/or peripheral device 24. Computer server(s) 42 may include one or more analyzing servers for analyzing the received data and/or one or more calculating servers for performing calculations on the received data. In an embodiment, various calculations and other processing described herein may be performed by one or more servers 42, the mobile app 34, or a combination of the servers 42 and the mobile app 34. For example, the mobile app 34 may send raw data to a server 42 or may perform processing on the data before sending the processed data to the server 42. Computer server(s) 42 and remote application 52 may also include one or more web servers running web applications that may allow a pharmacy 50, for example, caregivers 70, or others, such as the remote care team 80 to interact with the system 10 in defined roles. Computer servers 42 may also include storage servers for storing device information, medication information, patient information, billing information, etc.

In one embodiment of the disclosure, various data may be, for example, input and/or accessed by the patient 30, pharmacy 50, caregivers 70, or other users via terminals, such as personal computers (PCs), smart telephonic devices, and/or other hand-held wireless devices (e.g., tablet computer). The terminals may be coupled to a computer server 42, located in the cloud 40. The couplings 44 may include, for example, wired, wireless (e.g., Wi-Fi), Bluetooth, or fiber optic links.

The remote care team 80 may receive information from the cloud 40 regarding a patient 30. The remote care team, for example, may monitor for health changes and change prescription schedules.

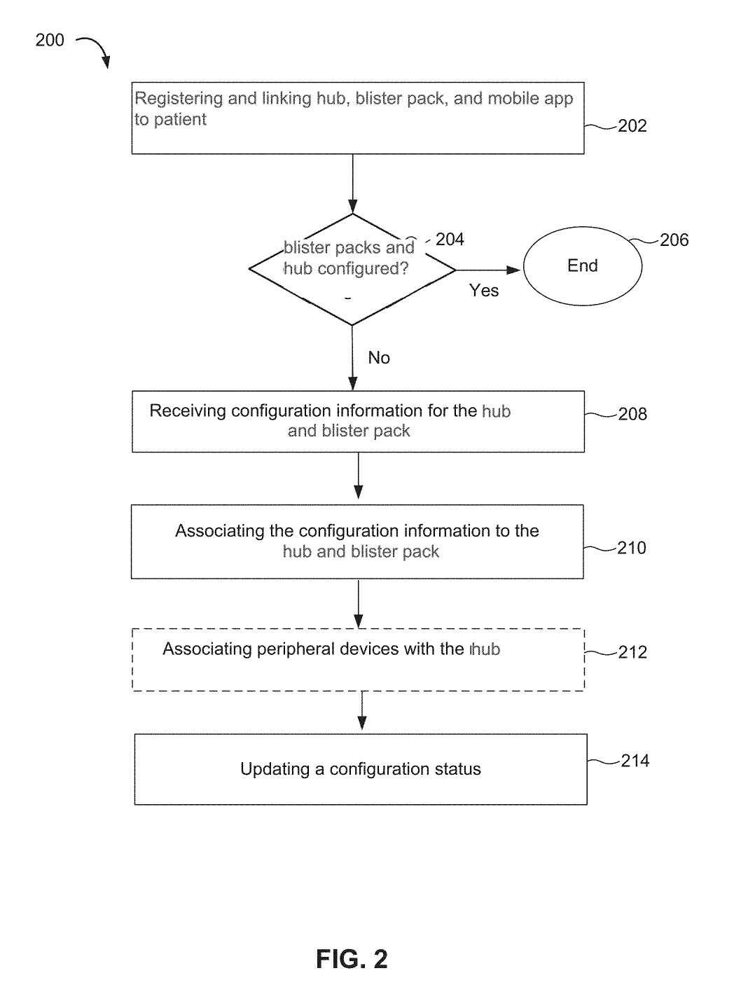

Referring now to FIG. 2, illustrated therein is an example method flow 200 for initializing a wellness system 10 in accordance with an embodiment. The method may include a step 202 of a manufacturer, caregiver, or pharmacist using the remote application 52 to register and link to the patient a hub 20, mobile app 34, and one or more blister packs 60. In an embodiment, each of the hub 20 and blister packs 60 include unique serial numbers that may be registered in the remote application 52. The hub 20 and/or blister packs 60 may also include unique identification tags, such as RFID tags, therefore allowing the cloud 40 to track the location of the hub 20 and blister packs 60 and expiration dates of the medication contained therein.

The method may also include determining whether the hub 20 and/or blister packs 60 has been configured 204. In an embodiment, the pharmacist may receive a hub 20 and blister packs 60 from a manufacturer and may check the device configuration status to determine whether the hub 20 and/or blister packs 60 have been previously set up with system 10 (FIG. 1). For example, when the device configuration status indicates that the hub 20 has previously registered with system 10, server 42 may determine that the hub 20 has been previously configured with system 10 and the method may end 206.

However, if, for example, server 42 determines that the hub 20 and blister pack 60 have not been configured with system 10, the method may include inputting configuration information for the hub 20 and blister pack 208. Configuration information may include, for example, patient information, medication information, and peripheral devices which may be connected to the hub. Patient information may include, but is not limited to, a patient name, a patient identification, patient contact information, caregivers' contact information, physician information, insurance information, medical history information, medical records, and appointment information. In addition, medication information may include, but is not limited to, medications prescribed to a patient, medication strength, medication dosage schedules, warnings, and instructions. The patient information and the medication information may be received by the system through user input. For example, an administrator may enter the patient information and medication information using remote application 52 (FIG. 1). In addition, the system may receive the patient information and the medication information from a medical provider. For example, server 42 may retrieve the medical information and/or patient information from a medical provider's computer system or other third party systems.

A patient account on server 42 may store the patient information, medication information, medical information, and/or health information received for the patient. For example, an administrator may create the patient account using remote application 52 and server 42 may identify the patient account using the patient identification. In addition, server 42 may update the patient account information to include the device identifier of the hub 20. As such, the system 10 may easily identify the hub 20 associated with the patient.

The method may also include associating the configuration information with the hub 20. In an embodiment, server 42 may synchronize the hub 20 with the patient account. Server 42 may transmit to the hub 20 (and/or the mobile app 34) the patient information, the medication information, medical information, and/or health information from the patient account. In addition, server 42 may transmit the patient information and medication information to the hub 20 and/or the mobile app 34 in real time or near real time as updates occur to the patient account.

Optionally, the method may include associating peripheral devices with the hub 212. For example, the administrator, the patient, a family member, and/or a caregiver of the patient may identify peripheral devices to associate with the hub. The peripheral devices may include any suitable device that may obtain medical or biometric data from a patient. For example, the peripheral devices may be a glucometer, cardiac monitor, thermometer, respiratory monitor, sleep monitor, pulse oximeter, body scale, inhaler, nebulizer, fitness tracker, blood pressure cuff, syringe, stethoscope, breathalyzer, mobile phone sensor, etc. In an embodiment, peripheral devices 24 (FIG. 1) may be connected to the hub 20 through a wired (e.g., universal serial bus (USB) connection or a wireless (e.g., Bluetooth, Bluetooth Low Energy or Wi-Fi) connection. For example, an administrator or a user may identify one or more peripheral devices 24 to connect to the hub 20 and may synchronize the selected peripheral devices 24 to the hub 20. Peripheral devices 24 may provide measurements or biometric data and/or other information to the hub 20, which may in turn transmit the relevant information to server 42 and/or other devices via the cloud 40. In addition, the peripheral devices 24 may include devices that are not coupled to the medication dispensing device and the patient may enter measurements or other readings taken by the peripheral device into the system.

In addition, the method may include updating a device configuration status 214. For example, when the hub 20 has been setup by the administrator, the server 42 may update the configuration status to indicate that the hub 20 is registered with the system 10.

Once the hub 20 and blister pack 60 has been set up by the administrator, the administrator or pharmacist may demonstrate to the patient 30 how the hub 20, mobile app 34 and blister pack 60 operate. For example, the administrator may schedule an appointment with the patient to demonstrate functions of the hub 20, mobile app 34, and blister pack 60 and any peripheral devices 24 the patient may need to use. The administrator may also explain to the patient any third party monitoring that may occur through the system 10. In another embodiment, a family member and/or caregiver of the patient may meet with the administrator to receive the hub 20 and blister pack 60.

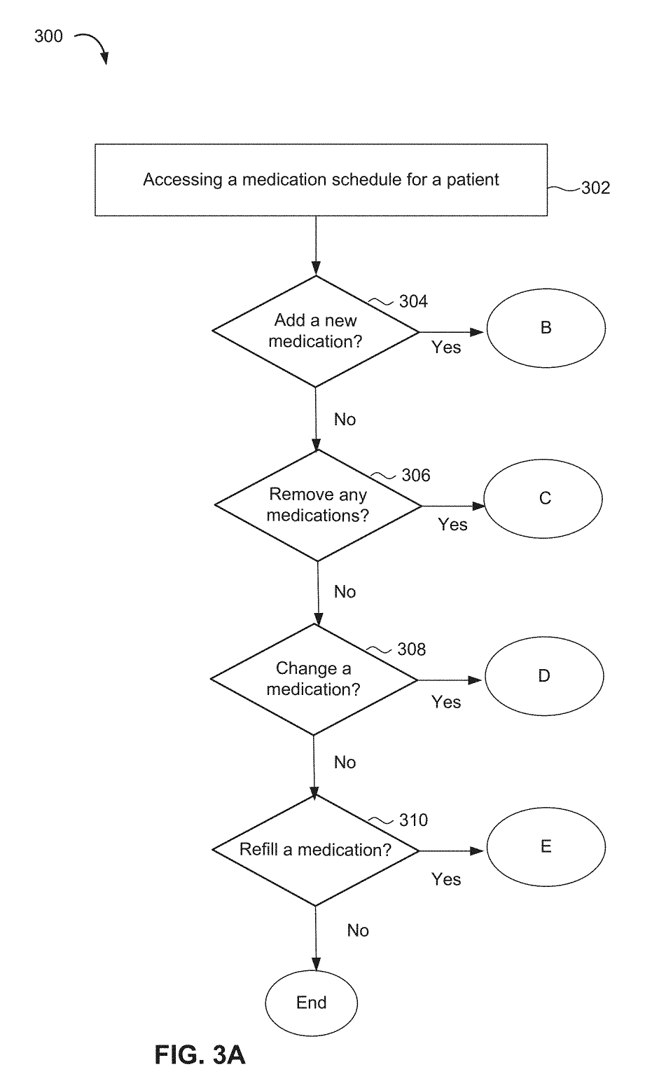

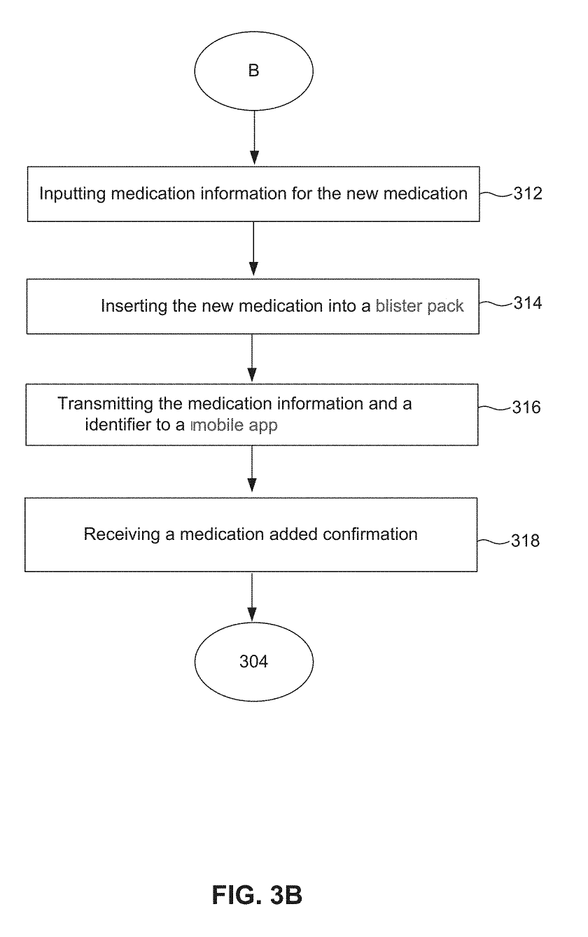

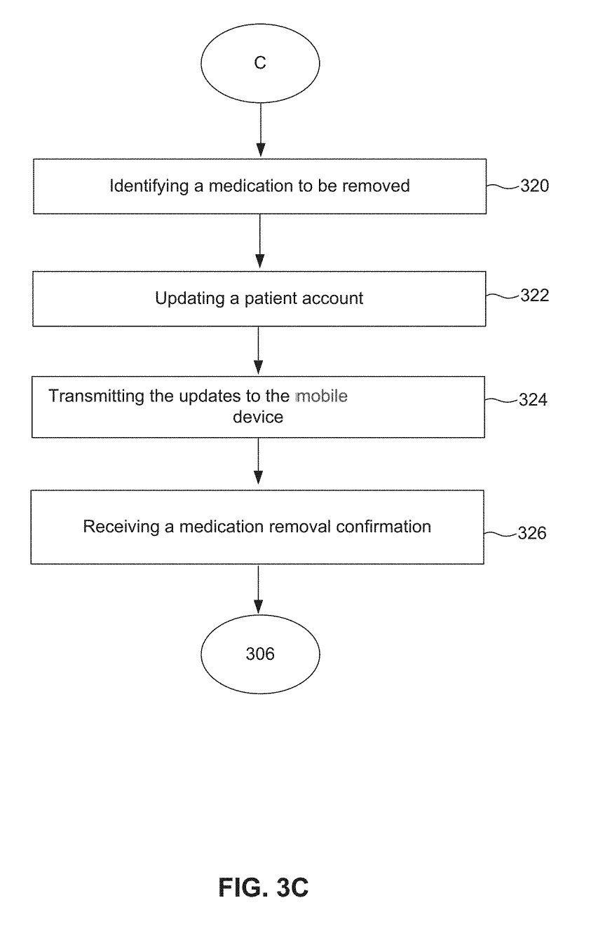

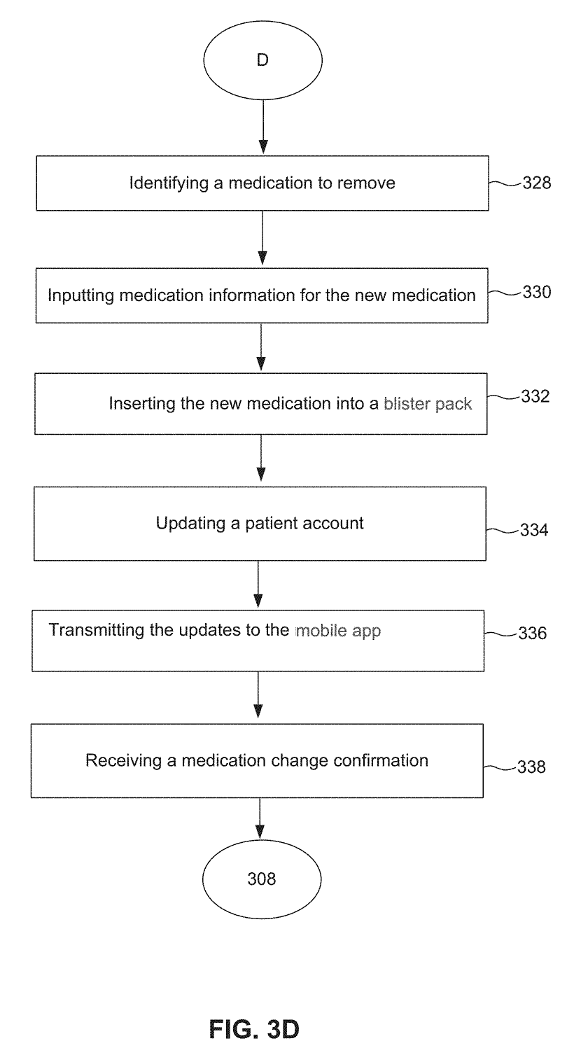

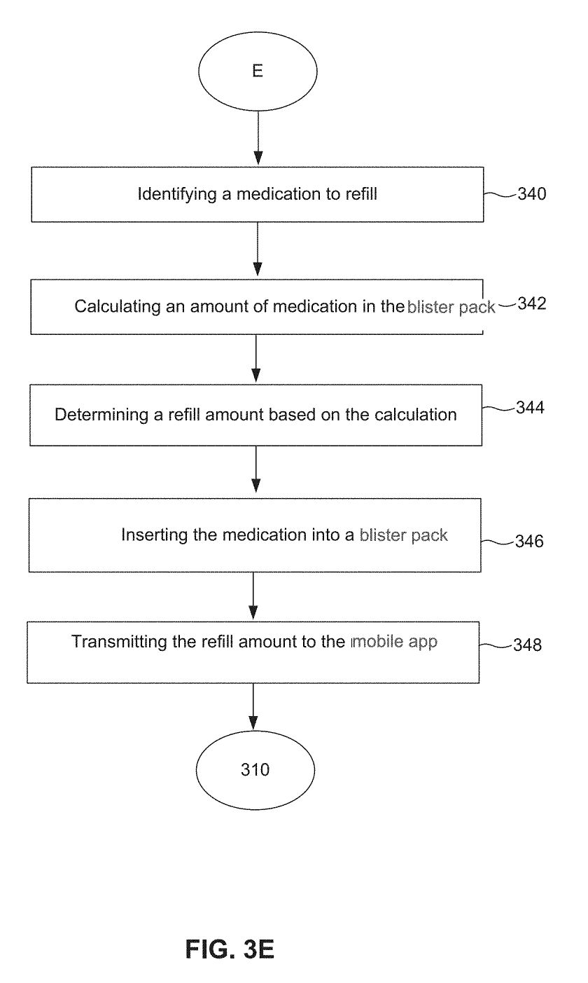

Referring now to FIGS. 3A-3E, illustrated therein is an example method flow 300 for managing a medication schedule for a patient in accordance with an embodiment. The method may include accessing a medication schedule for a patient 302. The medication schedule for the patient may be accessed, for example, by a pharmacist through the remote application 52 (FIG. 1). In an embodiment, the pharmacist may use the remote application 52 to access the patient account and identify the medication schedule for the patient.

The method may include determining whether a new medication should be added to the medication schedule for the patient in step 304 (FIG. 3A). For example, the pharmacist may determine that an additional medication has been added to a patient account. The pharmacist may receive prescription information from a doctor via written or electronic script, for example. In addition, the pharmacist may receive prescription information from the network 40 (FIG. 1) through the remote application 52. The pharmacist may also receive the prescription information from the patient.

When a new medication is to be added to the medication schedule, the method may include inputting medication information for the new medication in step 312 (FIG. 3B). In an embodiment, the pharmacist may use the remote application 52 to update a patient account with the medication information for the new medication. The medication information may include, but is not limited to, a medication name, a prescribed medication mass, a dosage mass/weight, a dosage schedule for the medication, medication warning, instructions for taking the medication, and/or other properties of a medication into the patient account.

The method may also include inserting the new medication into a blister pack in step 314. In an embodiment, a blister pack 60 may also be referred to as a medication container. In an embodiment, the pharmacist may use the remote application 52 to update the patient account with the amount of medication added to the blister pack (e.g., 30 pills added). In addition, the pharmacist may use the remote application 52 to update the patient account with a serial number of the blister pack, or any other form of identifier, so that server 42 may identify which blister pack 60 includes the new medication.

The method may also include transmitting the medication information and the identifier to the mobile app in step 316. For example, remote application 52 may access the mobile app 34 associated with the patient account and transmit the medication information and the identifier for the new medication to the mobile app 34.

The method may also include receiving a medication added confirmation in step 318. In an embodiment, remote application 52 may receive a medication added confirmation signal. For example, the remote application 52 may transmit a signal back to the server 42 confirming that the medication has been added to the blister pack 60.

The method may proceed to step 304 and may determine whether any additional medication should be added to the medication schedule for the patient.

If no additional medications should be added to the medication schedule, the method may include determining whether any medications should be removed from the medication schedule for the patient in step 306 (FIG. 3A). For example, the remote application 52 may indicate that a prescription for a patient may have ended for a particular medication and/or a medication has been removed from the medication schedule for the patient. The remote application 52 may receive an indication from server 42 that a patient account has been updated to remove a medication from the patients' medication schedule. In addition, the pharmacist may receive a notice from a medical provider indicating that a medication should be removed from the medication schedule for the patient.

The method may include identifying a medication to be removed from the medication schedule of the patient in step 320 (FIG. 3C). For example, the pharmacist may use the remote application 52 to identify a medication to be removed from the medication schedule of the patient. In addition, remote application 52 may access the patient account to identify the blister pack identifier associated with the medication to be removed from the patient's medical schedule.

The method may also include updating a patient account in step 322. The patient account may be updated to include the removal of the medication from the patient dosage schedule. For example, the pharmacist may use the remote application 52 to update the patient account.

The method may also include transmitting the updates to the mobile app 34 in step 324. For example, the remote application 52 may access mobile app 34 associated with the patient account and transmit the medication updates to the mobile app 34.

The method may also include receiving a medication removal confirmation from the remote application in step 326. For example, when a pharmacist removes a medication from a patient's dosage schedule, remote application 52 may transmit a signal back to server 42 confirming that the medication has been removed from the patient's dosage schedule. Server 42 may transmit the medication removal confirmation back to remote application 52.

The method may return to step 306 (FIG. 3A) and may determine whether any additional medications should be removed from the medication schedule of the patient.

If no additional medications should be removed, the method may include determining whether a medication should be changed in the medication schedule in step 308. If a medication should be changed for the medication schedule of the patient, the method may include identifying a medication to remove from the patient's dosage schedule in step 328 (FIG. 3D). For example, the pharmacist may use the remote application 52 to identify a medication to be removed from the medication schedule of the patient.

The method may also include inputting medication information for the new medication in step 330. In an embodiment, the pharmacist may use the remote application 52 to update a patient account with the medication information for the new medication.

The method may include inserting the new medication into a blister pack 60 in step 332. In an embodiment, the pharmacist may use the remote application 52 to update the patient account with the amount of medication added to the blister pack (e.g., 30 pills added to the blister pack). In addition, the pharmacist may use the remote application 52 to update the patient account with a serial number of the blister pack, or any other suitable form of identifier, so that server 42 may identify which blister pack 60 includes the new medication.

The method may also include updating a patient account 334. For example, the pharmacist may use the remote application 52 to update the patient account. The patient account may be updated to include the removal of the medication from the patient dosage schedule. In addition, the patient account may be updated to remove the identifier corresponding to the medication being removed from the patient's medical schedule. In addition, the pharmacist may use the remote application 52 to update the patient account with the amount of medication added to the blister pack (e.g., 30 pills added). In addition, the pharmacist may use the remote application 52 to update the patient account with a serial number of the blister pack, or any other suitable form of identifier, so that server 42 may identify which blister pack 60 includes the new medication.

The method may additionally include transmitting the updates to the mobile app in step 336. For example, remote application 52 may access the blister pack 60 identifier associated with the patient account and transmit the updates to mobile app 34. The mobile app 34 may prompt a patient via user interface 33 of the medication that should be removed and the medication that should be added to the blister pack 60.

The method may also include receiving a medication change confirmation from the medication dispensing device in step 338. The remote application 52 may receive a medication change confirmation signal transmitted from mobile app 34. Server 42 may transmit the medication change confirmation back to remote application 52.

The method may proceed to step 308 (FIG. 3A) and may determine whether any additional medications should be changed for the medication schedule.

If no additional medications should be changed, the method may proceed to step 310 and may include determining whether any medication should be refilled for the patient. If a medication should be refilled for the patient, the method may include identifying a medication to refill in step 340 (FIG. 3E). For example, a pharmacist may use remote application 52 to identify which medications may need to be refilled. The remote application 52 may receive a notification from the mobile app 34 indicating that a medication may need to be refilled. In addition, the remote application 52 may receive a notification from server 42 indicating that a medication may need to be refilled.

The method may also include calculating an amount of medication in a blister pack 60 in step 342. Server 42 and/or mobile app 34 may calculate a quantity of medication remaining in the blister pack 60 based on the number of blisters 61 not punctured by the patient. Server 42 may use the results to determine a quantity of medication remaining in the blister pack 60. Remote application 52 may receive the calculated amount of medication remaining in the blister pack from server 42.

The method may include determining a refill amount of medication based on the calculation in step 344. In an embodiment, remote application 52 may determine an amount of medication to refill based on the calculated amount of medication remaining in the blister pack. The pharmacist may have real-time visibility into the medication remaining in the blister pack and may be able to refill the medication with only an amount required to provide a quantity sufficient fill. For example, if a prescription is for 30 pills and the system calculates that 5 pills are still remaining in the blister pack, the system may determine that the amount of medication to refill should be 25 pills. By adjusting the amount of medication to refill based on the amount of medication remaining in the blister pack, the system may provide a quantity sufficient fill of the medication to the patient to ensure that the patient has an adequate supply of medication, without providing excess medication. In addition, by adjusting the refill based on the amount of medication remaining in the blister pack, the pharmacist may synchronize the refills to occur on the same date so that the patient may refill multiple medications on the same day without having to wait for each medication to be near completion.

The method may include inserting the refill amount of medication into a blister pack in step 346. In an embodiment, the pharmacist may use the remote application 52 to update the patient account with the amount of medication refilled in the blister pack. In addition, the pharmacist may use the remote application 52 to update the patient account with a serial number of the blister pack 60, or any other form of identifier, so that server 42 may identify which blister pack 60 includes the refilled medication.

The method may also include transmitting the refill amount to the mobile app in step 348. The refill amount may include an amount of medication refilled for the patient. For example, the remote application 52 may transmit the blister pack identifier and the amount of medication refilled for the patient to the mobile app 34 via network 40, for example.

As such, the system 10 may be used to manage the medication schedule of the patient.

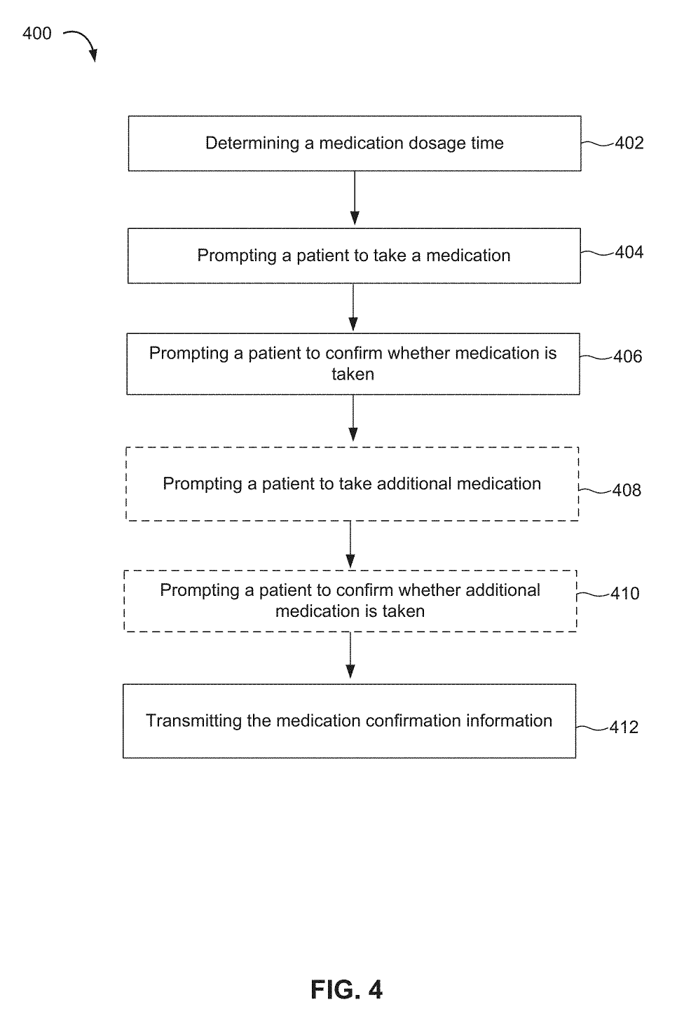

Referring now to FIG. 4, illustrated therein is an example method flow 400 for prompting a patient to take medicine in accordance with an embodiment. The method may include determining a medication dosage time in step 402. In an embodiment, the system 10 (FIG. 1) may access the medication information received from the mobile app 34, the remote application 52 and/or server 42 to determine a dosage time for the medication. For example, the system 10 may determine that a patient needs to take two medications in the morning based on the medication information received for the patient.

The method may also include prompting a patient to take a medication in step 404. For example, the system 10 (FIG. 1) may prompt a patient through the mobile app (FIG. 1) to take a medication. The user interface on the mobile app may display, for example, the time of day, a meal associated with the time of day (e.g., breakfast, lunch, dinner), the name of the medication(s), the purpose of the medication(s), a dosage amount of the medication(s), a picture of the medication(s), any instructions for taking the medication(s) (e.g., take with food), medication details, a current adherence or compliance score, and when a next dose of medication is due. User interface 33 may include an initial interface (e.g., a home screen interface) that may be presented when the patient opens or activates the mobile app 34. The initial interface may include, for example, a clock, upcoming medication dosage information, health and wellness information, goals, progress to goals, settings icon, a travel icon, a medication icon, and a banner message. The banner message may be a multipurpose message area where various notifications are presented to the patient, such as but not limited to, upcoming appointments, changes to any upcoming appointments, and an amount of time to the next medication dosage.

In an embodiment, the user interface 33 may present a reminder to the patient to take a medication. In another embodiment, the mobile app 34 may prompt the mobile device to transmit an audible reminder to the patient to take a medication. For example, when a patient approaches the mobile device 32, the mobile device 32 may detect the motion of the patient and send an audible reminder to the patient to take a medication. Also, when the patient opens or activates the mobile app 34, for example, by selecting a button and/or touching user interface 33, the mobile device 32 may send an audible reminder to the patient to take a medication. Audible reminders may include, but are not limited to, recorded messages, alarms, personalized voice messages, and sounds. An administrator, such as a pharmacist and/or patient may select preferences for the audible reminders when setting up the mobile app 34. In another embodiment, the mobile app 34 may also present visual reminders to the patient to take a medication. Visual reminders may include, for example, illuminating the display on the mobile device 32.

In addition, the mobile device 32 may transmit a message prompting the patient to take a medication. For example, the mobile app 34 may prompt a call, e-mail, and/or send a text message to the cellular telephone or other devices with a message notifying the patient that it is time to take one or more medications.

The mobile app 34 may also allow the patient to take a next dose early. For example, the patient may use user interface 33 to select the next dose of medication and the mobile app 34 may record the next dosage of medication for the patient as taken (for example, if a patient will be travelling and will not have access to the blister pack 60 at the next dosage time).

In an embodiment, the mobile app 34 (via the edge connector 66) may determine that the patient punctured or removed too many blisters 61 from the blister pack 60. Upon determining that the patient punctured or removed too many blisters 61, the mobile app 34 may transmit an alert and/or notification in real-time to the patient regarding the extra blisters 61 punctured. For example, the mobile device 32 may present a message on user interface 33 notifying the patient of the extra blisters removed/punctured with instructions to the patient for fixing the discrepancy (e.g., please do not take and replace the additional medication removed from the blister pack 60 until the next dosage window). In addition, the mobile device 32 may transmit an audible alarm to the patient notifying the patient of the extra blisters 61 punctured/removed. In an embodiment, the alert and notification will be transmitted to the patient 30 before the patient 30 ingests the incorrect amount of medication. In another embodiment, the message queries the patient as to whether the patient purposefully removed excessive blisters 61, for example, for upcoming travel purposes. In another embodiment, the patient's doctor, pharmacist, or caregiver will be alerted if the edge connector 66/mobile app 34 detects that an excessive amount of blisters 61 has been removed or punctured.

The method may also include prompting a patient to confirm whether the medication removed from the blister pack has actually been ingested 406. For example, user interface 33 may have an icon and/or button the patient may select confirming that the medication has been ingested. In addition, user interface 33 may have an icon or button allowing the patient to skip taking a dose of the medication. If the patient skips the dose of the medication, user interface 33 may prompt the patient to select a reason why the dose was skipped. For example, the patient may indicate that the medication will be taken at a later time, the medication is causing uncomfortable side effects, or the patient does not want to take the medication.

The method may optionally include prompting a patient to take additional medication in step 408. Additional medication may include, for example, other medication not included in the blister pack, such as insulin, vitamins, over the counter, and liquid solutions. User interface 33 may display the name of the additional medications, a dosage amount of the medication, a picture of the medications, any instructions for taking the medication (e.g., take with food), and medication details.

Optionally, the method may include prompting a patient to confirm whether the additional medication has been taken 410. For example, user interface 33 may have an icon and/or button the patient may select confirming that the additional medication has been taken. In addition, user interface 33 may have an icon and/or button allowing the patient to skip the additional medication. If the patient skips the medication, user interface 33 may prompt the patient to select a reason why the medication was skipped.

The method may also include transmitting medication confirmation information in step 412. For example, the mobile app 34 may transmit the medication confirmation information to the cloud 40.

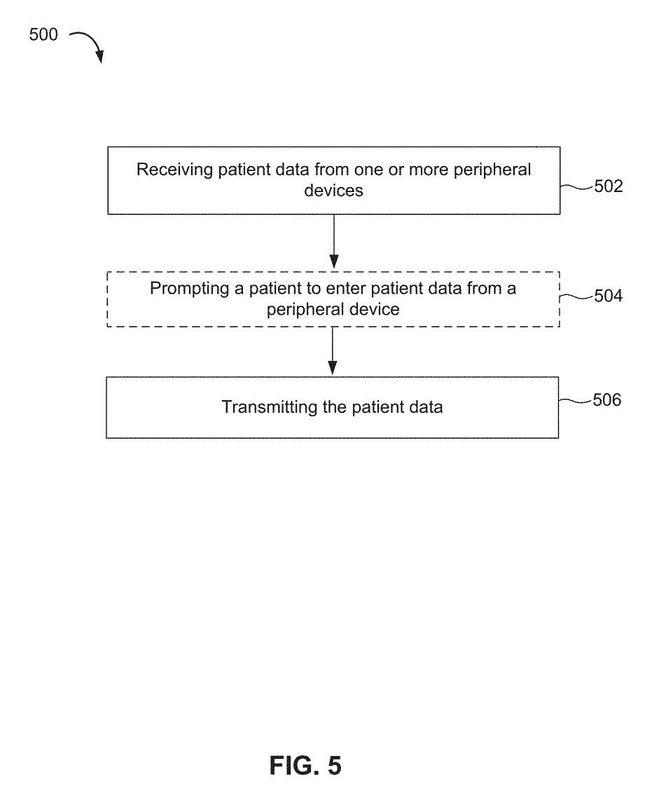

Referring now to FIG. 5, illustrated therein is an example method flow 500 for gathering information from peripheral devices 24 in accordance with an embodiment. The method 500 may include receiving patient data from one or more peripheral devices in step 502. Peripheral devices 24 may be any suitable device that may obtain medical or biometric data from a patient. For example, peripheral devices 24 may be a glucometer, cardiac monitor, thermometer, respiratory monitor, sleep monitor, pulse oximeter, body scale, inhaler, nebulizer, fitness tracker, blood pressure cuff, syringe, stethoscope, breathalyzer, mobile phone sensor, etc. In an embodiment, peripheral devices 24 (FIG. 1) may be connected to the hub (FIG. 1) through a wired (e.g., universal serial bus (USB) connection or a wireless (e.g., Bluetooth) connection. Peripheral devices 24 may be synchronized to the hub so that any measurements or biometric data collected by peripheral devices 24 may be automatically transmitted to the mobile app. The mobile app 34 may in turn transmit the measurements or biometric data to the cloud 40.

The method may optionally include prompting a patient to enter patient data from a peripheral device in step 504. Patient data may include medical or biometric data, as well as patient demographic data. Peripheral devices 24 may include devices that are not connected to the hub 20 and the patient may enter measurements and/or other readings taken by the peripheral device 24 using user interface 33. Example peripheral devices not connected to the medication dispensing device may include, but are not limited to, scales and a blood pressure cuff. User interface 33 may prompt a patient to enter patient data from one or more peripheral devices 24 not connected to hub 20. For example, the user interface 33 may prompt a user to enter the patient's weight.

The method may also include transmitting the patient data in step 506. For example, the mobile app 34 may transmit the patient data, measurements, and/or biometric data received from peripheral devices 24 and/or the patient to server 42 via the network 40. The mobile app or server 42 may use the received patient data, for example, to identify which peripheral devices 24 are being used by the patient, determine whether the patient data is within acceptable ranges for the disease state of the patient, determine the frequency in which the patient is using the peripheral devices, and a time of day in which the patient uses the peripheral devices.

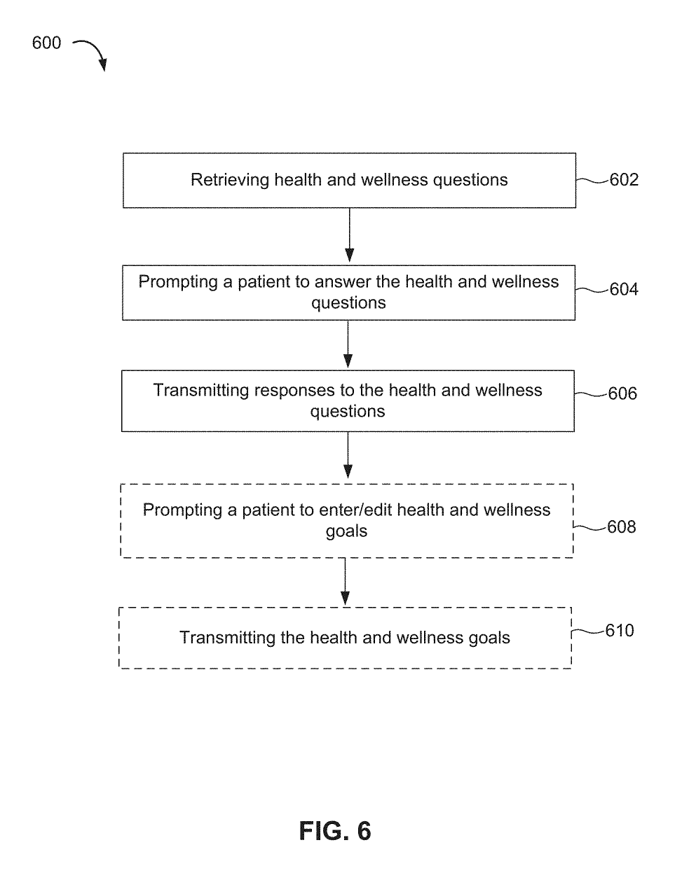

Referring now to FIG. 6, illustrated therein is an example method flow 600 for gathering health and wellness information in accordance with an embodiment. The method 600 may include retrieving health and wellness questions in step 602. In an embodiment, cloud 42 may transmit one or more health and wellness questions to the mobile app. The mobile app 34 may present the health and wellness questions to the patient via, for example, user interface 33. In another embodiment, the health and wellness questions may be transmitted to another device associated with the patient. The health and wellness questions may include subjective questions about the patient's health and wellness. For example, the health and wellness questions may include self diagnostic questions relating to the patient's mood, side effects of the medications, problems, and/or symptoms the patient may be experiencing (e.g., How are you feeling?). In addition, the health and wellness questions may include reporting questions (e.g., How did you sleep last night?).

The method may also include prompting a patient to answer the health and wellness questions in step 604. For example, the user interface 33 (FIG. 1) of the mobile app 34 (FIG. 1) may prompt the patient to answer one or more health and wellness questions. The patient may elect to answer the health and wellness questions. In an embodiment, the patient may select an option to answer the questions at a later time and/or skip answering the questions. If the patient selects to answer the questions at a later time and/or skip answering the questions, the method 600 may end.

In addition, the method may include transmitting responses to the health and wellness questions in step 606. For example, the mobile app 34 may transmit the responses received to the health and wellness questions to cloud 42 via network 40.

Optionally, the method may include prompting a patient to enter and/or edit health and wellness in step 608. User interface 33 may prompt the patient to enter one or more health and wellness goals. In addition, the patient may use user interface 33 to edit one or more health and wellness goals. For example, the patient may edit and/or remove an existing health and wellness goal (e.g., the number of steps taken in a day).

The method may also optionally include transmitting the health and wellness goals in step 610. For example, mobile app 34 may transmit the health and wellness goals to cloud 40.

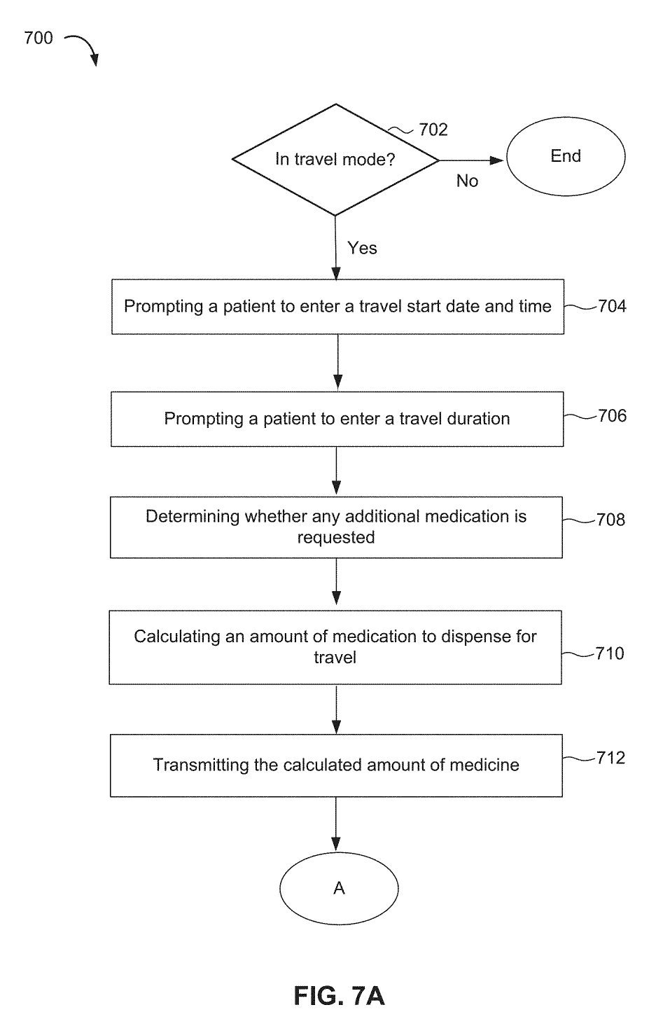

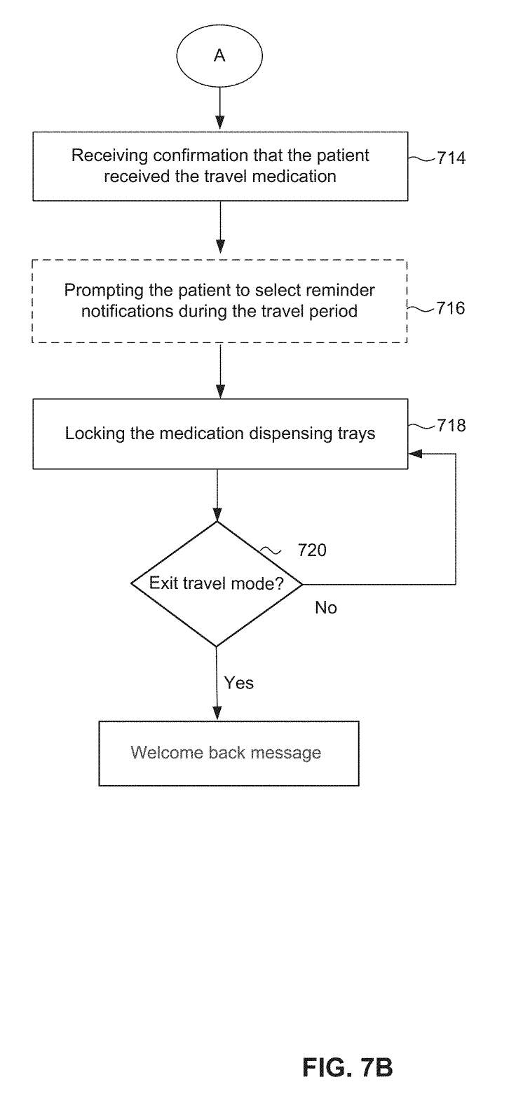

Referring now to FIGS. 7A and 7B, illustrated therein is an example method flow 700 for establishing a travel mode in accordance with an embodiment. The method 700 may include determining whether a travel mode is selected in step 702. For example, user interface 33 may prompt a patient to schedule upcoming travel so that the patient can remove any extra blisters required while the patient is travelling. The patient may select to schedule travel or select to not schedule travel.

When the patient selects to schedule travel, the method may include prompting a patient to enter a travel start date and time 704. For example, user interface 33 may prompt a patient to enter a start date and time. The patient may select the start date, for example, by clicking on a calendar, selecting a date from a pre-populated list of dates, or entering in the start date on user interface 33. In addition, the patient may select the start time by selecting a time on a clock, selecting the time from a pre-populated list of times, or entering in the start time on user interface 33. For example, the patient may enter in the start date and/or time using a keyboard displayed on user interface 33, speaking the start time, or using any other input mechanism.

The method may also include prompting a patient to enter a travel duration in step 706. For example, user interface 33 may prompt the patient to enter in the travel duration. The patient may select the duration, for example, from a list of days and/or a calendar. In addition, the patient may enter in the travel duration using a keyboard displayed on user interface 33, speaking the duration (e.g., voice recognition input), or using any other input mechanism.

In addition, the method may include determining whether additional medication is requested in step 708. For example, user interface 33 may prompt a patient to select whether any additional medication is requested to cover a delay in travel. The patient may select, for example, no additional medication and/or a number of days of additional medication.

The method may also include calculating an amount of extra blisters needed to be removed for travel in step 710. In an embodiment, the mobile app 34 may calculate an amount of blisters the patient should remove for the travel duration. For example, the mobile device may access the medication dosage schedule for the patient and multiply the medication dosage schedule for the travel duration.

The method may further include transmitting the calculated amount of medication in step 712. For example, the mobile app 34 may transmit the calculated amount of medication to the cloud 40. In an embodiment, the patient may use a pill organizer to organize the medication dispensed for travel. The user interface 33 may present a thumb nail view of the pill organizer illustrating where the dispensed medications should be placed in the pill organizer.

The method may also include receiving confirmation that the patient removed the travel medication in step 714. For example, user interface 33 may prompt the patient to confirm that the patient removed the travel medication by, for example, selecting a button to confirm.

Optionally, the method may include prompting a patient to select reminder notifications during the travel period in step 716. User interface 33 may prompt a user to select one or more notification methods for receiving dosage reminders while travelling. For example, the patient may select to be notified via e-mail message, text message, and/or telephone calls of upcoming medication dosages.

The method may also include having the mobile app 34 “lock” any more blisters 61 from being removed during the travel period. By locking the blisters 61, mobile app 34 may prevent extra medication from being removed from the blister pack 60 by the patient or another individual.

In addition, the method may include determining whether to exit the travel mode in step 720. Mobile app 34 may determine that the travel dates selected have ended and user interface 33 may prompt the patient to exit the travel mode. For example, user interface 33 may present to the patient a welcome back message allowing the patient to resume using the blister pack by selecting, for example, a button and/or an icon.

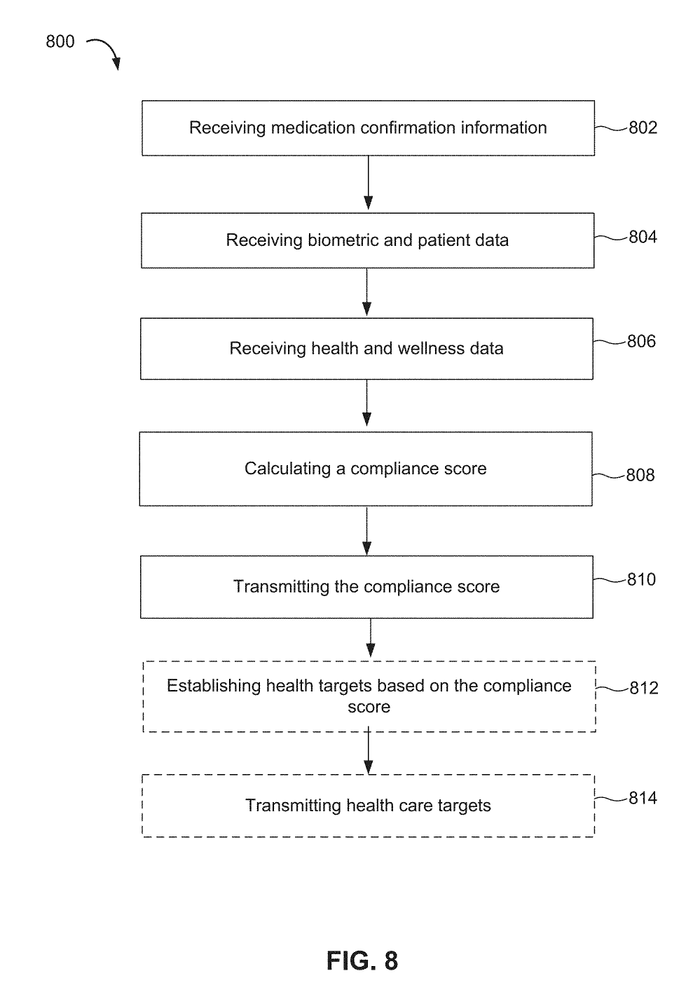

Referring now to FIG. 8, illustrated therein is an example method flow 800 for calculating a compliance score in accordance with an embodiment. The method may include receiving medication confirmation information in step 802. For example, the mobile app 34 or cloud 40 may receive medication confirmation information from the hub 20.

The method may also include receiving biometric data and patient data in step 804. In an embodiment, server 42 may receive biometric data and/or patient data from hub 20, mobile app 34, and/or peripheral devices 24.

In addition, the method may include receiving health and wellness data in step 806. For example, server 42 may receive health and wellness data from the mobile app 34.

The method may further include calculating a compliance score based on a medication dosage schedule for a patient in step 808. The compliance score may indicate a compliance percentage the patient has with regard to a medication regimen. For example, the compliance score may indicate a number of times a patient took a dose of medication within the allowed time window, whether the correct quantity of medication was consumed, and how often a patient is using the peripheral devices. In an embodiment, the mobile app 34 or server 42 may divide a number of times a medication has been taken by a patient by the total amount of medication prescribed to the patient. For example, if a patient takes a medication 27 times out of 30 times with the correct dose, the compliance score may indicate that the patient had a 90% compliance with the medication dosage schedule. In an embodiment, compliance scores of the patient may be aggregated over a period of time. For example, server 42 may determine the compliance percentage of the patient over 100 days (e.g., 90% to 99% over the 100 day period). In an embodiment, the compliance calculation may place a different weight or emphasis on different types of medication. For example, compliance with a critical blood pressure medication may have a greater impact on an overall compliance score than compliance with an optional nutritional supplement. The calculation may also place emphasis on medications to be taken at certain times of day, whether medications are prescription or over the counter, or those deemed critical to consume. The calculation may also take into account the degree to which other patients are compliant with the same type of medication or the same time of day. The calculation may be displayed in numerous ways: as a percentage, as a number of stars, as a letter grade (e.g., A, B, C, D, or F), thumbs up/down, or the like.

In an embodiment, server 42 (FIG. 1) may calculate a compliance score for biometric data and/or patient data received by the system. For example, servers may calculate a number of times a patient took a blood pressure measurement out of a total regiment provided to the patient to determine the compliance score for a medical reading.

The method may include transmitting the compliance score in step 810. For example, server 42 may transmit the compliance score to the mobile app 34 or the mobile app 34 may compute the compliance score locally on the mobile device 32. The mobile app 34 may present the compliance score to the patient via, for example, user interface 33. A patient may be able to view the compliance score in real time or at specified time periods (weekly, monthly, etc.). In addition, server 42 (FIG. 1) may transmit the compliance score to one or more devices and/or applications associated with the patient, caregivers, medical providers, and/or pharmacists. As such, caregivers, medical providers, and/or pharmacists may track when a medication was taken out of the medication dispensing device (e.g., a time stamp and date), evaluate a patient's compliance with the medication regimen, and monitor compliance with peripheral devices.

Optionally, the method may include establishing healthcare targets, for example, based on the compliance score in step 812. Healthcare targets may include a target percentage of medication compliance, a target blood pressure reading, and a target weight. In an embodiment, server 42 may use the compliance score, patient demographic data and/or health and wellness data received to establish healthcare targets for the patient.

The method may also optionally include transmitting the healthcare targets in step 814. For example, server 42 may transmit the healthcare targets to the mobile app 34. The mobile app 34 may present the healthcare targets to the patient and may also present a metric indicating how the patient may be measuring up to the healthcare targets via, for example, user interface 33. Thus, a patient may view the healthcare targets and how well the patient may be measuring up to the healthcare target. In addition, user interface 33 may present suggestions and/or recommendations for improving the patient's metrics for the healthcare targets. For example, a patient may be able to access health newsletters, health articles, blogs, Internet websites, videos, recipes, etc., with recommendations and/or suggestions for improving the patient's metrics for the healthcare targets. In addition, server 42 may transmit the healthcare targets to one or more devices and/or applications associated with the patient, caregivers, medical providers, and/or pharmacists.

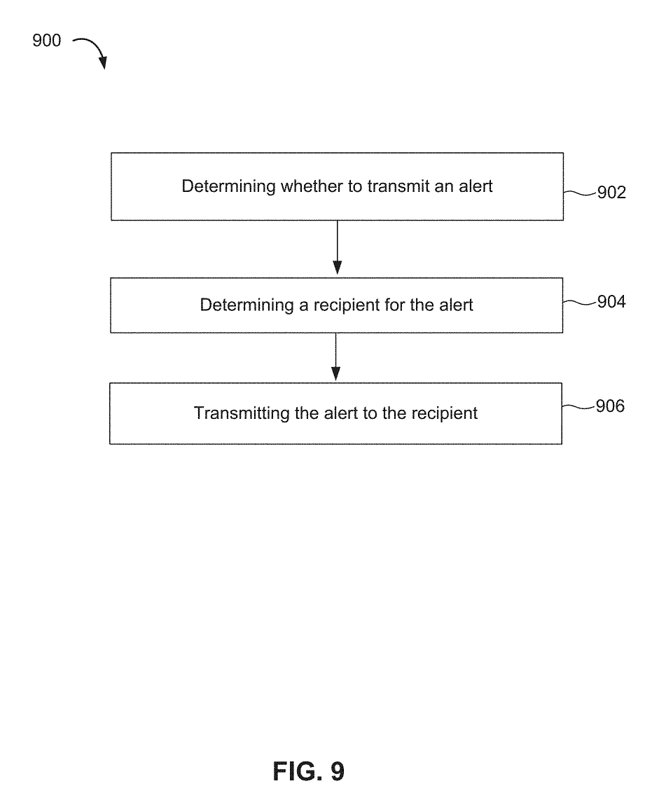

Referring now to FIG. 9, illustrated therein is an example method flow 900 for transmitting alerts in accordance with an embodiment. The method 900 may include determining whether to transmit an alert in step 902. For example, the mobile app 34 may determine or server 42 may receive one or more notifications indicating that an alert should be transmitted. Notifications may include, but are not limited to, error messages, medication dosage times, upcoming appointment reminders, missed medications, biometric readings in excess of a threshold level, biometric readings below a threshold level, measurements in excess of a threshold, measurements below a threshold level, medication refills notices, loss of medication, incorrect medication tray accessed, medication tray error, and incorrect medication dosage amount taken. Notifications may be transmitted to server 42 from mobile app 34 (FIG. 1), for example. In addition, notifications may be transmitted to server 42 from one or more peripheral devices 24 (FIG. 1) associated with a patient. Notifications may also be generated by the server 42 based on calculations performed by the server 42 (FIG. 1), for example.

The method may also include determining a recipient for the alert in step 904. Recipients may include, but are not limited to, a patient, a caregiver, a medical provider, a family member, a pharmacist, a hospital, and a payer. In an embodiment, server 42 may determine one or more recipients for receiving the alert based on the type of alert being transmitted and a reason for the alert. For example, if the biometric data received from a patient exceeds a recommend range and/or is below a recommended range, server 42 may determine that a medical provider should receive an alert based on the biometric data received. In addition, if the medical confirmation information indicates that the patient has missed several dosages of medication, server 42 may determine that an alert should be transmitted to a patient and a family member or caregivers of the patient.

In addition, the method may include transmitting the alert to the recipient in step 906. The alert may include the notification received and/or a customized message based on the notification. For example, server 42 may transmit the alert to the mobile app 34. In addition, server 42 may transmit the alert to a cellular telephone or other device associated with a patient, caregiver, family member, or medical provider of the patient. Server 42 may also transmit the alert to remote application 52 (FIG. 1).

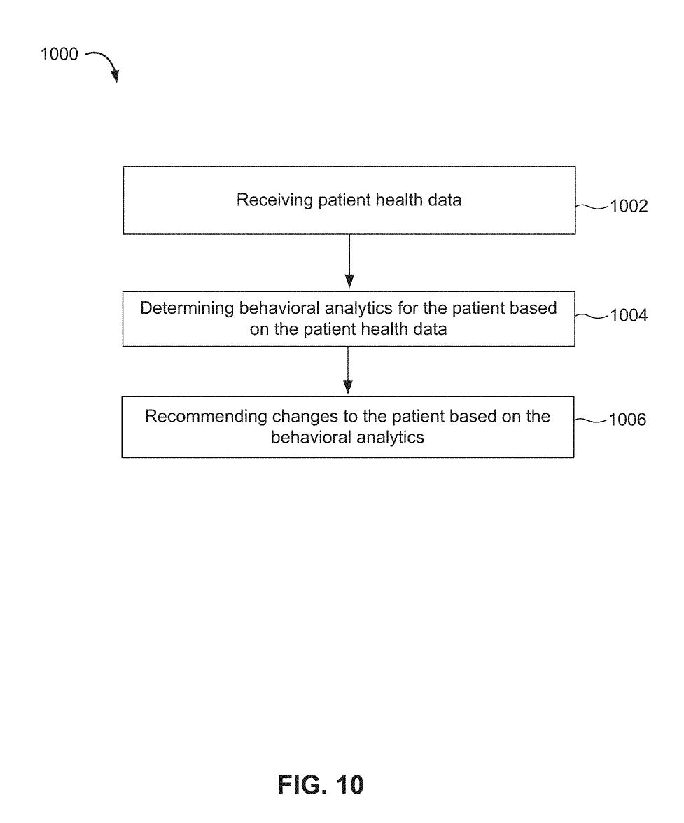

Referring now to FIG. 10, illustrated therein is an example method flow 1000 for determining behavioral analytics in accordance with an embodiment. The method 1000 may include receiving patient health data in step 1002. For example, server 42 may receive patient health data from one or more peripheral devices 24, the mobile app 34, a patient account, health and wellness questions responses, medical history information, and/or a patient.

The method may also include determining behavioral analytics for the patient based on the patient health data in step 1004. Behavioral analytics may include, but are not limited to, determining preferences of the patients, and determining preferences of a population of patients. Example behavioral analytics may include smoking, walking, sleep patterns, exercise, happiness, social activities, mental health, and work or school presentism. In an embodiment, server 42 may determine one or more behavioral analytics for the patient and/or a population of patients based on the patient health data received.

In addition, the method may include recommending changes to a patient based on the behavioral analytics in step 1006. In an embodiment, server 42 may automatically update the recommended changes. For example, if server 42 determines that a patient consistently takes a medication later in the morning than the scheduled dosage time, server 42 may automatically update the dosage time for the medication. In addition, server 42 may learn that the patient responds best to telephone calls. Thus, server 42 may automatically modify alert notifications to be sent to the patient via telephone calls. In another embodiment, sever 42 may suggest recommendations to the patient based on the determined behavioral analytics. For example, server 42 may determine that a population of patients with a similar disease state as the patient prefers to have a single appointment at the beginning of the month with the pharmacist to pick up medication refills. Server 42 may recommend to the patient to modify the patient's medication refill appointment based on the behavioral analytics of the population of patients. As such, the system may change alerts, medication dosage schedules, and/or patient recommendations, for example, as the system learns the behavior of the patient and/or a population of patients using the system.

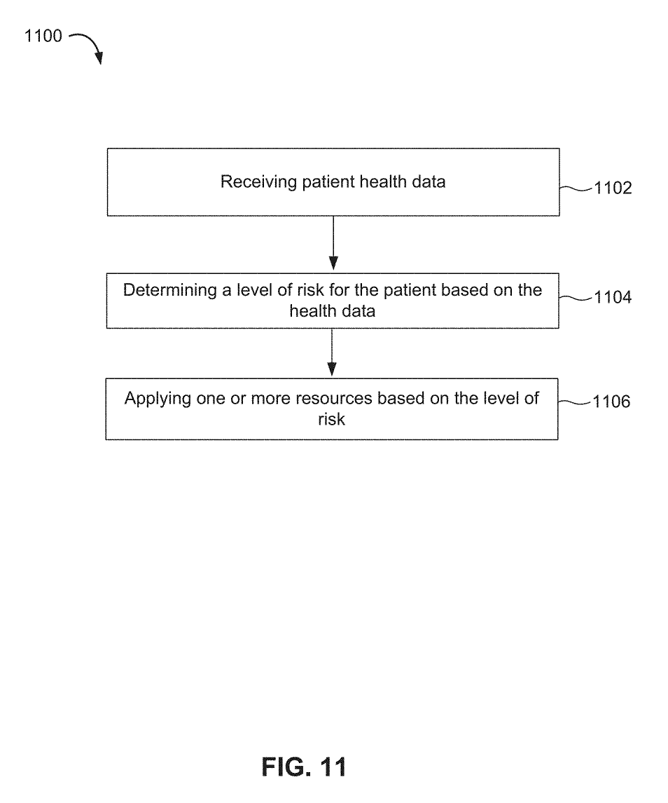

Referring now to FIG. 11, illustrated therein is an example method flow 1100 for risk management in accordance with an embodiment. The method 1100 may include receiving patient health data in step 1102. For example, server 42 may receive patient health data from one or more peripheral devices 24, mobile app 34, a patient account, health and wellness questions responses, medical history information, and a patient.

The method may also include determining a level of risk for the patient based on the health data in step 1104. For example, server 42 may analyze the patient's disease state, medical information, medication confirmation information, biometric readings, health and wellness information, and/or demographic data in determining the risk level for the patient.

The method may additionally include applying one or more resources based on the level of risk in step 1106. For example, server 42 may allocate more system resources to patients of higher risk than the amount of resources allocated to patients of lower risk. Server 42 may increase third party monitoring of the patient's health data, biometric measurements, and medication confirmation information, for example, when the system determines that the patient may be a high risk. In addition, server 42 may increase the amount of alerts and/or notifications transmitted to the patient, caregivers, family members, pharmacist, and medical providers when server 42 determines that the patient may be a high risk.

Embodiments of the disclosure may be implemented using hardware, software, or a combination thereof and may be implemented in one or more computer systems or other processing systems. In an embodiment of the disclosure, features are directed toward one or more computer systems capable of carrying out the functionality described herein.

While the foregoing disclosure discusses example embodiments and/or features, it should be noted that various changes and modifications could be made herein without departing from the scope of the described embodiments and/or features as defined by the appended claims. Furthermore, although elements of the described embodiments and/or features may be described or claimed in the singular, the plural is contemplated unless limitation to the singular is explicitly stated. Additionally, all or a portion of any embodiment and/or embodiment may be utilized with all or a portion of any other embodiment and/or feature, unless stated otherwise.

1. A medication system, comprising:
a blister pack including:
a sheet containing a plurality of blisters each respectively containing at least one medication;
a backing positioned on the sheet and including a substrate layer having electronic circuitry thereon, the circuitry including traces terminating at one end at positions corresponding to each of the blisters; and
an edge connector disposed adjacent to an edge of the sheet, the traces terminating at an other end to the edge connector; and
a hub in electronic communication with the blister pack;
wherein the traces positioned such that each time a blister is punctured, the breakage event is communicated to the hub and recorded.

2. The medication system of claim 1, wherein the edge connector is an electronic module that includes a communication device, a memory, a micro-controller, a clock, and a power source.

3. The medication system of claim 2, wherein the communication device includes Wi-Fi, Bluetooth, Bluetooth Low-Energy (BLE), or Zigbee.

4. The medication system of claim 2, wherein when a user punctures one of the blisters, the trace corresponding to the punctured blister sends a signal to the edge connector, whereby the clock within the edge connector records the time of the puncture in the memory, and the communication device sends a signal to the hub of the puncture.
